(19) United States
(12) Patent Application Publication
(10) Pub. No.: US 2017/0351036 A1
(43) Pub. Date: Dec. 7, 2017

(54) WET MATE FIBER OPTIC CONNECTOR

(71) Applicant: GE Oil & Gas UK Limited, Nailsea, Bristol (GB)

(72) Inventors: Keith David COVENTRY, Nailsea (GB); Silviu PUCHIANU, Nailsea (GB)

(21) Appl. No.: 15/524,847

(22) PCT Filed: Nov. 5, 2014
(86) PCT No.: PCT/EP2015/075845

§ 371 Date: May 5, 2017

(30) Foreign Application Priority Data
Nov. 6, 2014 (GB) 1419752.9

(51) Int. Cl. G02B 6/38; H04B 13/02; G02B 6/42; H04J 14/02

(52) U.S. Cl. CPC G02B 6/3816; H04J 14/02; H04B 13/02; G02B 6/3845; G02B 6/4215; G02B 6/4246

(57) ABSTRACT

A wet mate optical connector in combination with a wave division multiplexer, there being a plurality of input fiber optic cables on an input side of the multiplexer and a fiber optic cable on an output side of the multiplexer connected for providing multiplexed optical signals from the input cables to the wet mate connector.

### BACKGROUND

This invention relates to wet mate fiber optic connector, for example, a wet mate fiber optic connector for use in an underwater (e.g. subsea) hydrocarbon extraction facility.

In the subsea oil and gas industry, there is often a requirement to transmit data from a topside operations platform to control elements located at a hydrocarbon extraction facility on the sea bed. Additionally, there is often a requirement to transmit data from sensors at the extraction facility back up to the topside operations platform.

Usually a long offset umbilical is connected between the surface and the sea bed, with onward communication taking place via an optical flying lead. This lead needs to be capable of ‘wet mating’ with various modules which form the hydrocarbon extraction facility. This is done via an optical connector at the end of the optical flying lead.

In prior art systems, the optical flying lead contains a plurality of optical fibers which are each connectable to corresponding optical fibers in a module. However, these fibers can become damaged by the environment as they are exposed at the interface of the optical connector. Each connection is a point of weakness in the system, and so there is a desire to reduce the number of connections present in the optical connector to increase reliability.

### BRIEF DESCRIPTION

Embodiments of the present invention to provide a simpler, less expensive and more reliable fibers optic connector than that provided by prior art devices.

In accordance with an aspect of the present invention there is provided a wet mate optical connector in combination with a wave division multiplexer, there being a plurality of input fiber optic cables on an input side of the multiplexer and a fiber optic cable on an output side of the multiplexer connected for providing multiplexed optical signals from the input cables to the wet mate connector.

In accordance with an aspect of the present invention there is provided a method of connecting an optical flying lead to a power and communications distribution module, the method comprising the steps of: providing a wave division multiplexer in an optical connector; connecting a plurality of input fiber optic cables in the optical flying lead to an input side of the multiplexer; providing a fiber optic cable on an output side of the multiplexer connected for providing multiplexed optical signals from the input cables to an interface of the optical connector; and wet mating the optical connector to the power and communications distribution module; distribution module of an underwater hydrocarbon extraction facility.

Optionally, the plurality of input fiber optic cables could be disposed in an optical flying lead.

The wet mate optical connector could be included in a subsea data communication system. The wet mate optical connector in such a subsea data communication system could connect the optical flying lead to a power and communications distribution module. The power and communications distribution module contains a further wave division multiplexer arranged to demultiplex the multiplexed optical signals. The power and communications distribution module could contain a plurality of electrical to optical data converters, and wherein each demultiplexed optical signal is converted to an electrical signal by a respective electrical to optical data converter. In that case, each electrical signal could be transmitted to a respective subsea electronics module of a respective subsea control module of an underwater hydrocarbon extraction facility.

### BRIEF DESCRIPTION OF THE DRAWINGS

The invention will now be described by way of example with reference to the accompanying drawings, in which:

FIG. 1 schematically shows a prior art wet mate connector;

FIG. 2 shows a wet mate connector according to a first embodiment;

FIG. 3 shows the wet mate connector of FIG. 2 used as a component in a subsea communications system; and

FIG. 4 shows the wet mate connector of FIG. 2 used as a component in another subsea communications system

### DETAILED DESCRIPTION

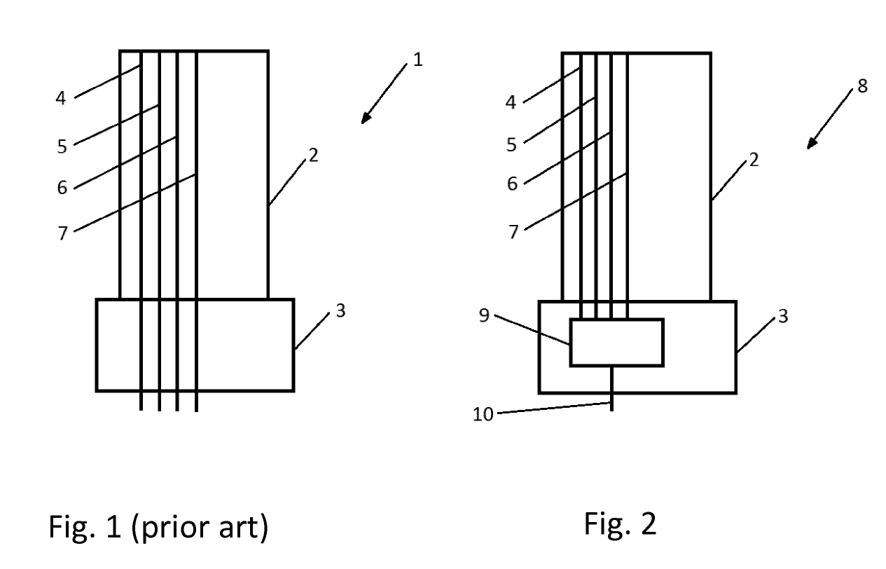

FIG. 1 schematically shows a prior art wet mate connector 1. The wet mate connector 1 comprises two main parts: an optical flying lead 2 and an optical connector 3. When used as part of a subsea communications system, the optical flying lead 2 is usually connected at a first end to a long offset umbilical (not shown), which runs from a surface location (topside) to a subsea location, with the optical connector 3 connected at a second end of the optical flying lead 2.

The optical flying lead 3 comprises a plurality of optical fibers 4, 5, 6 and 7. These optical fibers carry optical communications data signals, with each optical fiber transmitting electromagnetic (EM) radiation of a respective one of different wavelengths λ₁, λ₂, λ₃, λ₄. In prior art wet mate connectors, for example such as that shown in FIG. 1, each of these optical fibers runs from the optical flying lead 2 through the interface of the optical connector 3 for downstream connection to further respective optical fibers.

FIG. 2 shows a wet mate connector 8 according to a first embodiment. Like components from FIG. 1 have retained their reference numerals.

In the wet mate connector shown in FIG. 2, each of the number of optical fibers 4, 5, 6 and 7 runs from the optical flying lead 2 into a wave division multiplexer 9 contained in the optical connector 3. The wave division multiplexer 9 combines the optical communications data signals from each of the optical fibers 4, 5, 6 and 7 using the technique of wave division multiplexing, which is well-known in the art, and the combined optical communication data signal is transmitted down a single optical fiber 10.

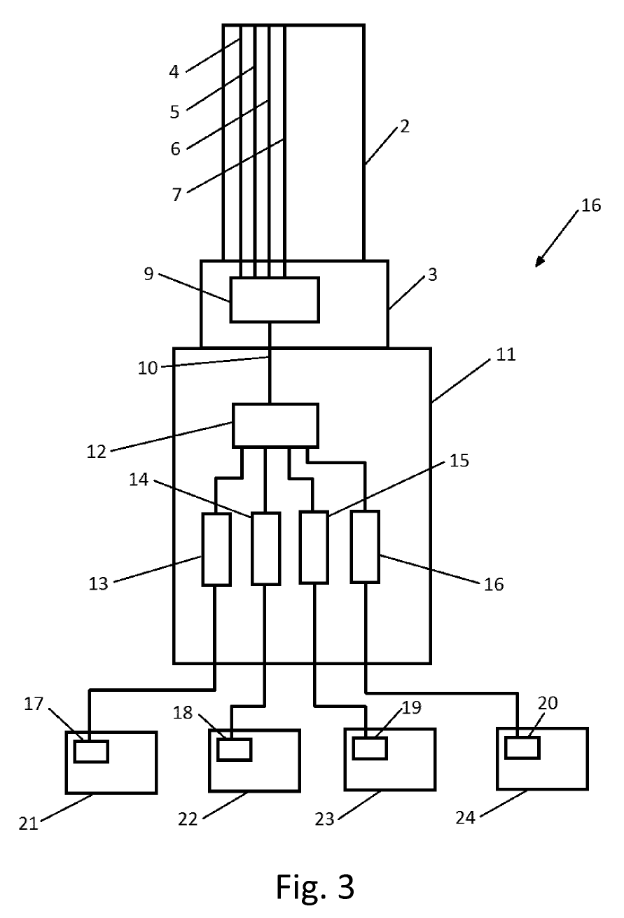

FIG. 3 shows part of a subsea communications system 16 for an underwater hydrocarbon extraction facility. Like components from FIG. 2 have retained their reference numerals.

The single optical fiber 10 from the wet mate connector of FIG. 2 is shown connected to a power and communications distribution module (PCDM) 11.

The PCDM 11 contains a wave division demultiplexer 12. The optical fiber 10 from the wet mate connector is connected to the wave division demultiplexer 12, and the combined optical communication data signal is demultiplexed back into optical communications signals of their original respective wavelengths λ₁, λ₂, λ₃ and λ₄.

Each of the respective optical communications signals from optical fibers 4, 5, 6 and 7 is then transmitted to a respective one of electrical to optical data converters (EODCs) 13, 14, 15 and 16. The optical communication signals are converted from optical signals to electrical signals by the EODCs 13, 14, 15 and 16, and passed to a respective subsea electronics modules (SEMs) 17, 18, 19 and 20 in respective subsea control modules (SCMs) 21, 22, 23 and 24.

Data from sensors in the SCMs can be sent back to topside by reversing this process. Electrical communications signals are generated by the SEMs 17, 18, 19 and 20 and transmitted to respective ones of the EODCs 13, 14, 15 and 16. The optical communication signals are converted from electrical signals to optical signals by the EODCs 13, 14, 15 and 16, and passed to the demultiplexer 12, which in this process acts as a multiplexer to combine each of the optical signals from the EODCs 13, 14, 15 and 16. The resultant optical communications signal is transmitted through the optical fiber 10 to the multiplexer 9, which in this process acts as a demultiplexer. The combined optical communication data signal is demultiplexed back into optical communications signals of their original respective wavelengths λ₁, λ₂, λ₃ and λ₄, and transmitted along respective ones of the plurality of optical fibers 4, 5, 6 and 7 in the optical flying lead 2 to an end of the long offset umbilical (not shown). From here, the optical communications signals can be transmitted to the surface location.

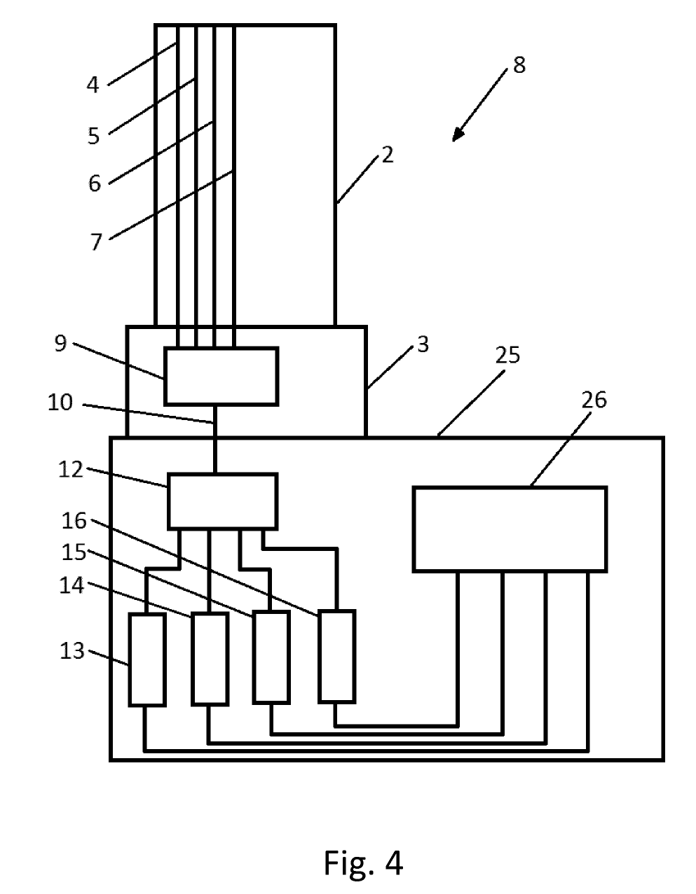

In an alternative set-up to that shown in FIG. 3, the optical connector 3 could be mated to a SCM directly without the need for an intermediate PCDM. This is shown in FIG. 4, in which like reference numerals from FIGS. 2 and 3 are retained.

The single optical fiber 10 from the wet mate connector of FIG. 2 is shown connected to a SCM 25. The SCM contains the demultiplexer 12 and EODCs 13, 14, 15 and 16 which were contained in a PCDM in FIG. 3. The optical fiber 10 from the wet mate connector is connected to the wave division demultiplexer 12, and the combined optical communication data signal is demultiplexed back into optical communications signals of their original respective wavelengths λ₁, λ₂, λ₃ and λ₄.

Each of the respective optical communications signals from optical fibers 4, 5, 6 and 7 is then transmitted to a respective one of electrical to optical data converters (EODCs) 13, 14, 15 and 16. The optical communication signals are converted from optical signals to electrical signals by the EODCs 13, 14, 15 and 16, and passed to a SEM 26 of the SCM 25.

There are numerous advantages associated with embodiments of the present invention. For example, embodiments enable a simple and reliable configuration using passive components. This allows for smaller, cheaper connectors. The optical connector is easily retrievable if connection fails.

One advantage of embodiments of the present invention is that it enables the transmission of high power signals. Optical fibers have a maximum safe level of power that they can transmit. By using embodiments of the present invention, multiple replicas of the same signal can be sent down the various optical fibers (for example, using an optical splitter), each signal being at the maximum safe power level for its respective optical fiber. At a termination end of the optical fibers, the multiple signals could be recombined using a multiplexer to produce a power signal of higher power than the carrying capacity of any one optical fiber.

Using the technique above also provides safety via redundancy in a communication system. For example, if one of the optical fibers was cut, the signal would still be transmitted through to its destination (albeit at a lower power level). Such a system would be useful in subsea communications systems, for example, connecting a master control station to a topside termination unit.

The invention is not limited to the specific embodiments described, and other possibilities will be apparent to those skilled in the art. For example, although the combined communication data signal is sent down a single optic fiber in the embodiments of FIGS. 2 to 4, the invention is intended to cover any reduction in the number of connections in the optical connector.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

1. A wet mate optical connector comprising:
a wave division multiplexer in combination with the wet mate optical connector;
a plurality of input fiber optic cables on an input side of the multiplexer;
a fiber optic cable on an output side of the multiplexer connected for providing multiplexed optical signals from the input cables to the wet mate connector.

2. A wet mate optical connector according to claim 1, wherein the plurality of input fiber optic cables are disposed in an optical flying lead.

3. A subsea data communication system comprising:
a wet mate optical connector comprising:
a wave division multiplexer in combination with the wet mate optical connector;
a plurality of input fiber optic cables on an input side of the multiplexer;
a fiber optic cable on an output side of the multiplexer connected for providing multiplexed optical signals from the input cables to the wet mate connector.

4. A subsea data communication system according to claim 3, wherein the wet mate optical connector connects the optical flying lead to a power and communications distribution module.

5. A subsea data communication system according to claim 4, wherein the power and communications distribution module contains a further wave division multiplexer arranged to demultiplex the multiplexed optical signals.

6. A subsea data communication system according to claim 5, wherein the power and communications distribution module contains a plurality of electrical to optical data converters, and wherein each demultiplexed optical signal is converted to an electrical signal by a respective one of the electrical to optical data converters.

7. A subsea data communication system according to claim 6, wherein each electrical signal is transmitted to a respective subsea electronics module of a respective subsea control module of an underwater hydrocarbon extraction facility.

8. A method of connecting an optical flying lead to a power and communications distribution module, the method comprising:
providing a wave division multiplexer in an optical connector;
connecting a plurality of input fiber optic cables in the optical flying lead to an input side of the multiplexer;
providing a fiber optic cable on an output side of the multiplexer connected for providing multiplexed optical signals from the input cables to an interface of the optical connector; and
wet mating the optical connector to the power and communications distribution module.

9. A method according to claim 8, wherein each of the plurality of input fiber optic cables carries an optical communication data signal of a different respective wavelength.

10. A method according to claim 8, wherein the power and communications distribution module contains a further wave division multiplexer arranged to demultiplex the multiplexed optical signals.

11. A method according to claim 10, wherein the power and communications distribution module contains a plurality of electrical to optical data converters, and wherein each demultiplexed optical signal is converted to an electrical signal by a respective one of the electrical to optical data converters.

12. A method according to claim 11, wherein each electrical signal is transmitted to a respective subsea electronics module of a respective subsea control module of an underwater hydrocarbon extraction facility.

13. (canceled)

14. (canceled)

15. (canceled)
